(19) United States
(12) Patent Application Publication
(10) Pub. No.: US 2025/0272639 A1
(43) Pub. Date: Aug. 28, 2025

(54) SYSTEMS AND METHODS FOR GENERATING WORKFLOWS BASED ON NATURAL LANGUAGE INPUTS USING LARGE LANGUAGE MODELS

(71) Applicant: ServiceNow, Inc., Santa Clara, CA (US)

(72) Inventors: Jason Allen Lefever, Hopedale, MA (US); Alberto Alvarado Jiminez, San Diego, CA (US); Brian Paul Bimschleger, Highland Park, IL (US); Jacob Samuel Burman, Carlsbad, CA (US); Ian Chandler Eichenberg, Carlsbad, CA (US); Adam Emon Golab, San Jose, CA (US); Yaron Guez, San Diego, CA (US); Jan Ove Kristian Olsson, Castro Valley, CA (US); Michel Abou Samah, San Diego, CA (US); Paul Seymour, San Anselmo, CA (US); Ofer Vaisler, San Jose, CA (US)

(21) Appl. No.: 18/588,492

(22) Filed: Feb. 27, 2024

(51) Int. Cl. G06Q 10/0633

(52) U.S. Cl. CPC G06Q 10/0633

(57) ABSTRACT

A method includes receiving a natural language request to generate a workflow, where the natural language request specifies at least one characteristic of the workflow, generating, using one or more large language models (LLMs), a skeleton workflow based on the at least one characteristic, where the skeleton workflow includes first and second placeholder activities, and where the first placeholder activity comprises a first placeholder value for a first property of the first placeholder activity receiving an input requesting to modify the skeleton workflow, and updating the skeleton workflow based on the input.

### BACKGROUND

The present disclosure relates generally to designing workflows, and more specifically to reducing resources utilized in designing workflows.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In cloud-based architectures, a web browser or native application is often used on the client side to access cloud-based applications and resources. For example, an enterprise or other organization may utilize cloud computing resources to design workflows for processes that are performed by members of the enterprise or organization during operation. However, generating and modifying workflows for processes can be tedious and time consuming. Typically, workflow generation tools are used to generate a workflow from scratch, based on activities associated with the workflow. For example, activities that are be performed during the workflow, stages (e.g., groupings) of activities within the workflow, how some activities within the workflow may be dependent on outputs from other activities in the workflow, or from external sources (e.g., a database, approval from a user profile, activities from other workflows, etc.), the order of activities within the workflow, whether activities can be performed in parallel, and so forth.

The workflow generation tool typically builds a workflow activity-by-activity. For each activity in the workflow, the workflow generation tool specifies, or receives input specifying, the properties of the activity, such as inputs, outputs, actions that take place to generate the outputs based on the inputs, a label, a description, rules to apply during performance of the activity, triggers that initiate the activity, advanced properties of the activity, and so forth. Even in low-code or no-code environments, building workflows using a series of graphical user interfaces (GUIs) with characteristics selected from groups of available options (e.g., drop-down menus), is a time-consuming process. Further, once the workflow has been created, the workflow generation tool, or a GUI design tool, generates the GUIs presented as the workflow is performed. Techniques for making the creation of workflows faster, more efficient, and a better experience for workflow designers are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving a natural language request to generate a workflow, where the natural language request specifies at least one characteristic of the workflow, generating, using one or more large language models (LLMs), a skeleton workflow based on the at least one characteristic, where the skeleton workflow includes first and second placeholder activities, and where the first placeholder activity includes a first placeholder value for a first property of the first placeholder activity receiving an input requesting to modify the skeleton workflow, and updating the skeleton workflow based on the input.

In another embodiment, a system includes processing circuitry and a memory. The memory is accessible by the processing circuitry and stores instructions that, when executed by the processing circuitry, cause the processing circuitry to receive a natural language request to generate a workflow, where the natural language request specifies at least one characteristic of the workflow, generate, using one or more large language models (LLMs), a skeleton workflow based on the at least one characteristic, where the skeleton workflow includes first and second placeholder activities, and where the first placeholder activity includes a first placeholder value for a first property of the first placeholder activity, receive an input requesting to modify the skeleton workflow, update the skeleton workflow based on the input, receive an approval of the updated skeleton workflow, and generate, in response to receiving the approval of the skeleton workflow, the workflow based on the approved updated skeleton workflow.

In a further embodiment, a non-transitory, computer readable medium stores instructions that, when executed by processing circuitry, cause the processing circuitry to receive a natural language request to generate a workflow, where the natural language request specifies at least one characteristic of the workflow, generate, using one or more large language models (LLMs), a skeleton workflow based on the at least one characteristic, where the skeleton workflow includes first and second placeholder activities, and where the first placeholder activity includes a first placeholder value for a first property of the first placeholder activity, generate one or more graphical user interfaces (GUIs) configured to be displayed via a client device as the workflow is carried out, receive an input requesting to modify the skeleton workflow, and update the skeleton workflow based on the input.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 is a screenshot of a GUI for submitting a request for a new workflow, in accordance with aspects of the present disclosure;

FIG. 6 is a screenshot of a GUI for reviewing and modifying a skeleton workflow for credit card fraud investigation generated by an LLM-based generative AI workflow generation tool in response to a prompt submitted using the GUI of FIG. 5, in accordance with aspects of the present disclosure;

FIG. 7 is a screenshot of the GUI of FIG. 6, including an add activity window, in accordance with aspects of the present disclosure;

FIG. 8 illustrates an embodiment of the add activity window of FIG. 7, in which a create task activity has been selected from an activities list, in accordance with aspects of the present disclosure;

FIG. 9 is an embodiment of the add activity window of FIG. 7 in which a send email activity has been selected from the activities list, in accordance with aspects of the present disclosure;

FIG. 10 is an embodiment of the add activity window of FIG. 7 in which a checklist task activity has been selected from the activities list, in accordance with aspects of the present disclosure;

FIG. 11 is an embodiment of the add activity window of FIG. 7 illustrating recommended activities to replace a placeholder activity, in accordance with aspects of the present disclosure;

FIG. 12 illustrates the workflow of FIG. 7 displayed in a diagram mode, in accordance with aspects of the present disclosure;

FIG. 13 illustrates an embodiment in which the workflow generation tool makes suggestions for modifying the workflow via a popup window, in accordance with aspects of the present disclosure;

FIG. 14 illustrates an embodiment in which the workflow generation tool makes suggestions for modifying the workflow via an interactive chat window, in accordance with aspects of the present disclosure;

FIG. 15 illustrates the GUI of FIG. 13 in which a review fraud risk score placeholder activity has been replaced with a new fully defined activity, in accordance with aspects of the present disclosure; and

FIG. 16 is a flow chart of a process for generating a workflow, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Various embodiments disclosed herein are directed to a workflow generation tool that builds workflows, and in some cases entire playbooks (e.g., complete workflows along with GUIs presented as the workflow is performed), based on natural language inputs provided via the workflow generation tool, using large language models (LLMs). Specifically, a natural language input identifying one or more characteristics of a workflow to be generated may be provided via the workflow generation tool (e.g., “I would like to create an onboarding workflow”). The workflow generation tool utilizes one or more LLMs to generate a skeleton workflow, including multiple placeholder activities, which may or may not be grouped into stages. The one or more LLMs may be trained on existing workflows (e.g., within the enterprise, across an industry, across multiple industries, etc.), business process model and notation (BPMN) conventions, industry standard operating procedures, industry best practices, publicly available information, publications, data from the Internet, and so forth. The one or more LLMs may build the skeleton workflow placeholder activity by placeholder activity, with each placeholder activity having proposed placeholder values for the one or more properties of the corresponding activity. For example, a placeholder activity of the skeleton workflow may include proposed placeholder values for inputs, outputs, actions that take place to generate the outputs based on the inputs, a label, a description, rules to apply during performance of the activity, triggers that initiate the activity, advanced properties of the activity, or some combination thereof.

A skeleton workflow generated by the workflow generation tool may be displayed via the workflow generation tool, which may receive inputs making edits to the skeleton workflow and/or providing feedback to the workflow generation tool. For example, the inputs may confirm proposed placeholder values or provide replacement values for one or more properties of the activity, provide values for one or more properties of the activity where placeholder values were not provided by the workflow generation tool, add new activities, remove activities, replace placeholder activities with activities selected from an activity library or new activities, and so forth. Further, in some embodiments, the workflow generation tool may present suggestions for replacing placeholder activities with activities from a library when a placeholder activity is selected. In further embodiments, the workflow generation tool may include a chat interface by which feedback on the skeleton workflow may be provided in natural language and the workflow generation tool uses the one or more LLMs to make changes to the skeleton workflow based on the feedback provided. Once the properties for all of the activities in the skeleton workflow have been finalized, the skeleton workflow may be finalized and a usable workflow generated.

In some embodiments, the workflow generation tool may be configured to generate a complete playbook, which includes a complete workflow, as opposed to a skeleton workflow, along with one or more GUIs to be displayed as the workflow is performed. In such embodiments, changes to the complete workflow may be received (e.g., add/remove activities, specify different values for activity properties, etc.), and/or feedback on the playbook received via a chat interface or the workflow generation tool, which may cause the workflow generation tool to make changes to the playbook based on the feedback received via the workflow generation tool.

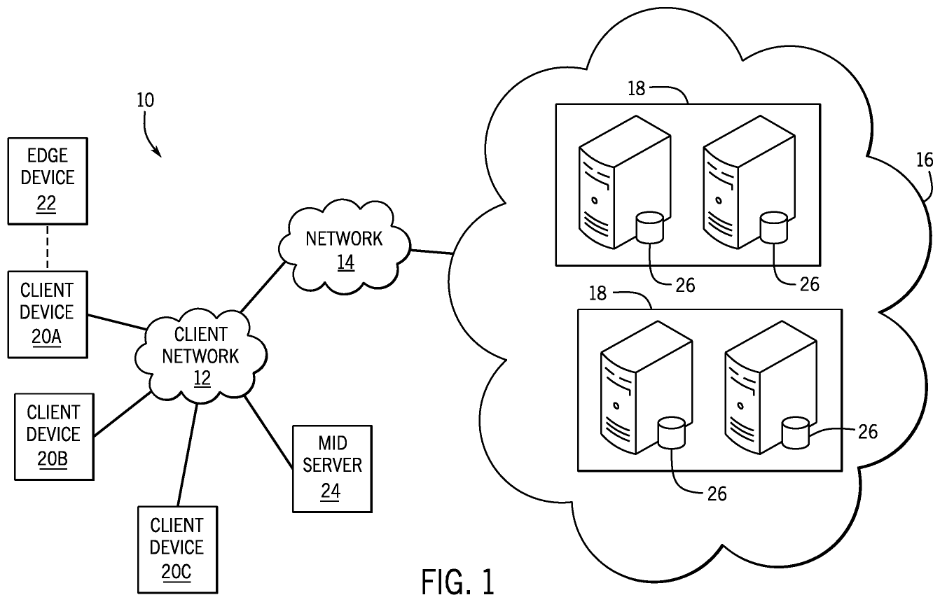

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial application, device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

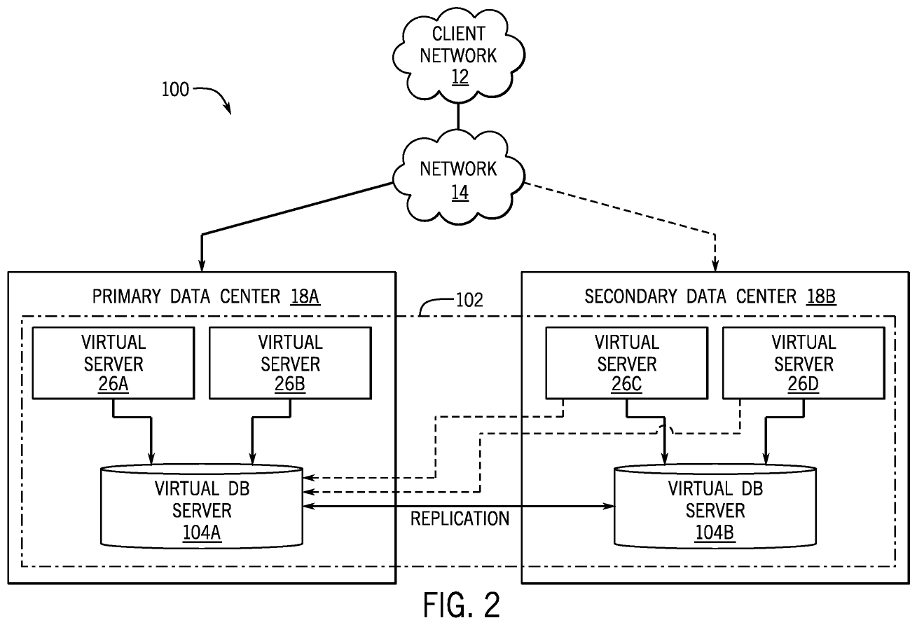

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

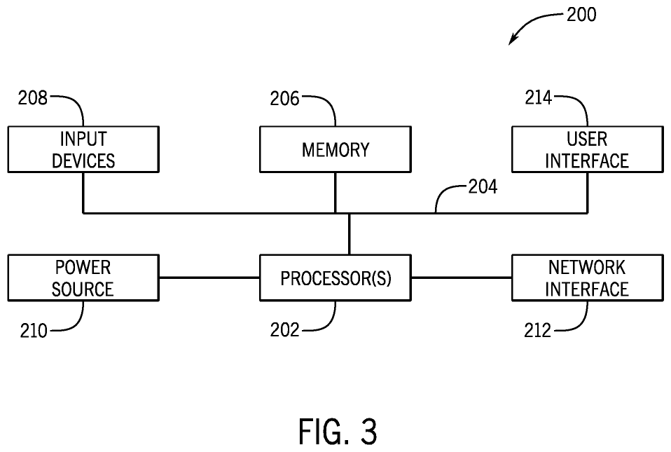

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

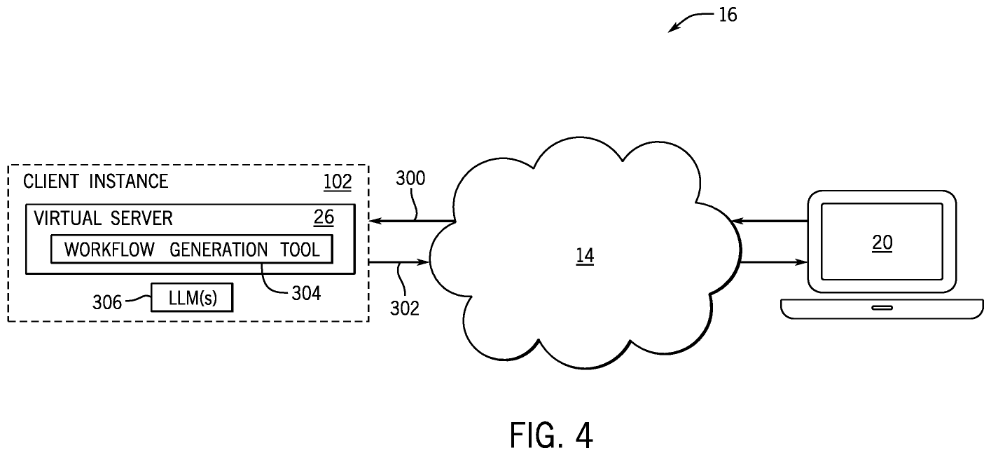

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a workflow generation tool 304, which may be a software application defined by code, accessible via a native application or web browser of the client device 20. Accordingly, the inputs 300 may include inputs requesting a workflow, specifying one or more characteristics of a workflow, providing feedback on a generated workflow, requesting modifications to a workflow, and so forth. Correspondingly, the outputs 302 may include requested workflows (e.g., skeleton workflows, partially complete workflows, complete workflows, etc.), responses to inputs 300, questions, and so forth. The workflow generation tool 304 may utilize one or more large language models 306 (LLMs), which may be stored within the client instance 102 or accessible to the client instance 102, to generate some or all of the outputs 302. As used herein, a large language model (LLMs) is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with workflows, as well as tasks beyond the scope of workflow generation and modification.

Traditionally, generating and modifying workflows for processes using workflow generation tools has been tedious and time consuming. For example, workflows were typically built from scratch, using workflow generation tools to define activities performed during the workflow, stages (e.g., groupings) of activities within the workflow, how some activities within the workflow may be dependent on outputs from other activities in the workflow, or from external data sources, the order of activities within the workflow, whether activities can be performed in parallel, and so forth. Accordingly, workflows tend to be built activity-by-activity, using the workflow generation tools to specify, for each activity in the workflow, the properties of the activity, such as inputs, outputs, actions that take place to generate the outputs based on the inputs, a label, a description, rules to apply during performance of the activity, triggers that initiate the activity, advanced properties of the activity, and so forth. Even in low-code or no-code environments, building workflows using a series of graphical user interfaces (GUIs) with characteristics selected from groups of available options (e.g., drop-down menus), is a time-consuming process prone to human error. Further, once the workflow has been created, the workflow generation tool, or a GUI design tool, generates the GUIs presented as the workflow is performed. Techniques for making the creation of workflows faster, more efficient, and a better experience for workflow designers are needed. Faster and more efficient workflow generation is associated with lower processor utilization and reduces computational costs.

The presently disclosed workflow generation tool 304 receives natural language inputs and uses the LLMs 306 to automatically build workflows based on the inputs, and in some cases entire playbooks (e.g., complete workflows along with GUIs presented as the workflow is performed). As used herein, “natural language” is intended as language, either written, typed, or spoken by a human being. Accordingly, a natural language input may be one or more human-readable alphanumeric character strings, or audio, the meaning of which may be understood by a human. As shown in FIG. 4, the workflow generation tool 304 may receive a natural language input 300 from the client device, such as “I would like to create a credit card fraud investigation workflow.” The workflow generation tool 304 utilizes the one or more LLMs 306 to generate a skeleton workflow, including multiple placeholder activities, which may or may not be grouped into stages, as an output 302. As used herein, a workflow is a sequence of activities or steps that combine to form a process performed in the operation of an enterprise or organization. Correspondingly, a skeleton workflow is a workflow made up of multiple activities wherein at least one of the multiple activities has undefined or unspecified properties or parameters. The one or more LLMs 306 may be trained, for example, on existing workflows (e.g., within the enterprise, across an industry, across multiple industries, etc.), business process model and notation (BPMN) conventions, industry standard operating procedures, industry best practices, publicly available information, publications, data from the Internet, and so forth. In some embodiments, the one or more LLMs 306 may be “off the shelf” or “out of the box” LLMs 306 provided by a service provider and not unique to the client instance 102. However, in other embodiments, the LLMs may be customized to the client instance 102, either with specific training, specific customized settings, or both.

As is described in more detail below, the workflow generation tool 304 may use the one or more LLMs 306 to build the skeleton workflow placeholder-activity-by-placeholder-activity. Each placeholder activity may include proposed placeholder values for one or more properties of the corresponding placeholder activity. For example, a placeholder activity of the skeleton workflow may include proposed placeholder values for inputs, outputs, actions that take place to generate the outputs based on the inputs, a label, a description, rules to apply during performance of the activity, triggers that initiate the activity, advanced properties of the activity, or some combination thereof.

As shown in FIG. 4, the skeleton workflow generated by the workflow generation tool 304 may be transmitted to the client device 20 as an output 302 for display via the client device 20 by way of a native application (e.g., a corresponding client-side version of the workflow generation tool 304) or a web browser. The client device 20 may receive inputs requesting modifications to or making edits to the skeleton workflow, and/or providing feedback to the workflow generation tool. The edits/modifications may be made to a local copy of the skeleton workflow stored on the client device 20, or transmitted by the client device 20 o the client instance 102 as inputs 300 for modification of a copy of the skeleton workflow stored by the client instance 102.

For example, the inputs may confirm proposed placeholder values or provide replacement values for one or more properties of the activity, provide values for one or more properties of the activity where placeholder values were not provided by the workflow generation tool 304, add new activities, remove activities, replace placeholder activities with activities selected from an activity library or new activities, and so forth. Further, in some embodiments, the workflow generation tool 304 may present, via the client device 20, suggestions for replacing placeholder activities with activities from a library when a placeholder activity is selected. In further embodiments, the workflow generation tool 304 may include a chat interface by which feedback on the skeleton workflow may be provided in natural language and the workflow generation tool 304 uses the one or more LLMs 306 to make changes to the skeleton workflow based on the feedback provided. Once the properties for all of the activities in the skeleton workflow have been defined, the skeleton workflow may be finalized (e.g., via an approval received via the client device 20) and a usable workflow generated by the workflow generation tool 304.

In some embodiments, the workflow generation tool 304 may be configured to generate a complete playbook, which includes a complete workflow, as opposed to a skeleton workflow, along with one or more GUIs to be displayed by a client device 20 as the workflow is performed. As used herein, a complete workflow is a workflow having multiple activities, wherein all of the activities in the workflow have fully defined properties. Accordingly, none of the activities in a complete workflow have undefined parameters. In such embodiments, changes to the complete workflow may be received (e.g., add/remove activities, specify different values for activity properties, etc.), and/or feedback on the playbook received via a chat interface or the workflow generation tool, which may cause the workflow generation tool to make changes to the playbook based on the feedback received via the workflow generation tool.

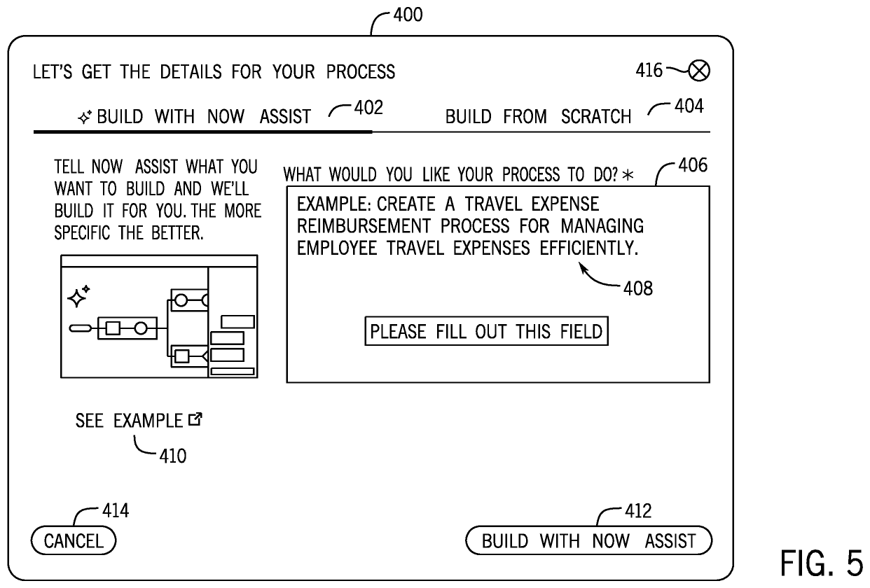

With the foregoing in mind, FIGS. 5-16 represent example screenshots of GUIs that may be displayed via a client device during creation of a new workflow and/or modification of an existing workflow. It should be understood, however, that the screenshots depicted in FIGS. 5-16 are merely examples and that embodiments having different GUIs are envisaged. Specifically, FIG. 5 is a screenshot 400 of a GUI for submitting a request for a new workflow. As illustrated, the GUI for submitting a request for a new workflow includes first tab 402 and a second tab 404. The first tab 402, when selected, uses Now Assist (e.g., an LLM-based generative artificial intelligence workflow generation tool) to generate the new workflow. The second tab 404, when selected, allows a workflow to be built manually from scratch. Though the present disclosure is mostly directed to using the LLM-based generative AI capabilities of the workflow generation tool, it should be understood that the workflow generation tool may also be used to build workflows from scratch.

When the first tab 402 is selected (e.g., the LLM-based generative AI workflow generation tool is being used), the GUI includes a prompt window 406 in which a prompt (e.g., an input describing one or more characteristics of the workflow to be created) is provided. As shown, before a prompt is provided, the prompt window 406 may display an example prompt 408 (e.g., “Create a travel expense reimbursement process for managing employee travel expenses efficiently”). In some embodiments, the GUI may also include a link to an example demo 410, that, when selected, provides an example demonstration for how to use the LLM-based generative AI workflow generation tool. Once a prompt has been provided in the prompt window 406, the build button 412 may be selected to provide the prompt as an input to the LLM-based generative AI workflow generation tool to generate a workflow based on the prompt. In the instant embodiment, as is discussed below regarding the subsequent figures, assume the submitted prompt was a request to create a workflow for credit card fraud investigation, however, it should be understood that this is merely an example and that embodiments are envisaged in which the LLM-based generative AI workflow generation tool generates workflows for processes beyond credit card fraud investigation.

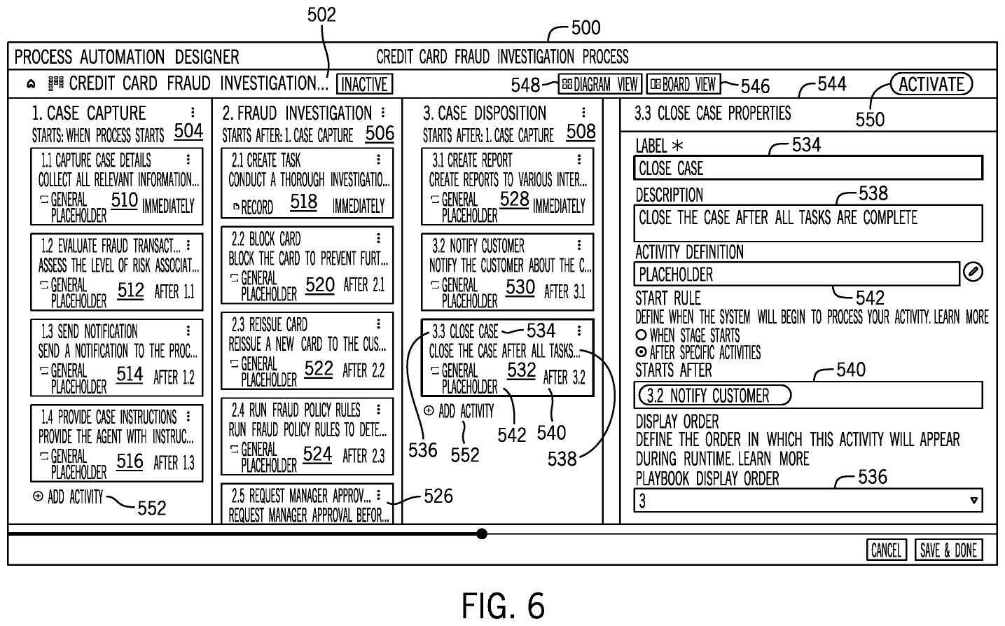

As shown, the GUI may include a cancel button 414 and/or a close window button 416 to close the GUI without creating a new workflow. Assuming that the submitted prompt includes a request for a new credit card fraud investigation workflow, the LLM-based generative AI workflow generation tool may receive the prompt and generate a skeleton workflow. FIG. 6 is a screenshot of a GUI 500 for reviewing and modifying a skeleton workflow 502 for credit card fraud investigation generated by the LLM-based generative AI workflow generation tool in response to the submitted prompt. As shown, the skeleton workflow includes one or more stages. In the embodiment shown in FIG. 6, the skeleton workflow 502 includes a case capture stage 504, a fraud investigation stage 506, and a case disposition stage 508. However, it should be understood that the skeleton workflow 502 shown in FIG. 6 is merely an example and that other skeleton workflows may have more stages, fewer stages, different stages, and so forth. Each of the stages 504, 506, 508 of the skeleton workflow 502 may include one or more placeholder activities. For example, the case capture stage 504 includes a capture case details activity 510, an evaluate fraud transaction activity 512, a send notification activity 514, and a provide case instructions activity 516. The fraud investigation stage 506 includes a create task activity 518, a block card activity 520, a reissue card activity 522, a run fraud policy rules activity 524, and a request manager approval activity 526. The case disposition stage 508 includes a create report activity 528, a notify customer activity 530, and a close case activity 532. It should be understood, however, that the skeleton workflow 502 shown in FIG. 6 is merely an example and that other skeleton workflows are envisaged having different stages and/or placeholder activities.

As shown in FIG. 6, each of the placeholder activities may be represented by a card displaying certain information about the corresponding activity. For example, the cards shown in FIG. 6 include a label field 534, an activity display order field 536, a description field 538, a trigger field 540, and an activity definition field 542. The label field 534 indicates the title given to the activity (e.g., “close case” for activity 532). The activity display order field 536 indicates the activity's display sequence within the workflow 502. In the instant embodiment, the activity display order field 536 includes the stage number, a period, and then the number of the activity within the stage (e.g., “3.3” for activity 532), however other notations are also envisaged (e.g., indicating a stage with a letter and the activity's position within the stage with a number, such as “A.1”, indicating a stage with a number and the activity's position within the stage with a letter, such as “1.A”, indicating the stage by it's number within the whole workflow, etc.). The description field 538 may provide a more detailed description of the activity. The trigger field 540 indicates the condition that triggers initiation of the activity. The activity definition field 542 indicates the type or definition of the activity. For example, is the activity a placeholder activity, is the activity a record generating activity, and so forth.

When an activity card is selected, an activity properties window 544 is displayed. The activity properties window 544 displays editable properties of the corresponding activities that may or may not be displayed on the face of the activity card. For example, in the embodiments shown in FIG. 6, the close case activity 532 card has been selected, so the activity properties window 544 displays properties of the close case activity 532, which may be modified by providing inputs to the GUI. For example, as shown, the activity properties window 544 allows inputs to be provided to change the label field 534, the description field 538, the activity definition field 542, define the trigger condition for the activity, such as when the stage starts, after a specific activity, etc., and the activity display order 536. By further defining properties of placeholder activities, placeholder activities may be fully defined and converted into usable activities. However, it should be understood that the activity properties window 544 shown in FIG. 6 is merely an example and that embodiments are envisaged in which the activity properties window 544 includes different fields, has a different design, shows data in a different way, and so forth.

In some embodiments, grab, drag, and drop inputs may be provided to move activities to different locations within the workflow 502, such as in a different stage, a different display order within the stage, and so forth. Accordingly, in some embodiments, when the card is moved, the properties of the activity may be automatically updated to reflect the activity card's new position within the workflow. Correspondingly, if inputs are provided via the activity properties window 544 modifying a property of the activity, such as the activity display order, the activity card may be updated to reflect the modified property or properties (e.g., different location, new value, etc.).

In the embodiment shown in FIG. 6, a board mode 546 is selected, with stages represented as vertical lanes and activity cards stacked vertically within their respective stage lanes. However, as is shown and described below, when a diagram mode 548 is selected, the workflow may be displayed as a flow chart with activities represented as boxes connected by arrows that indicate how the workflow progresses through activities.

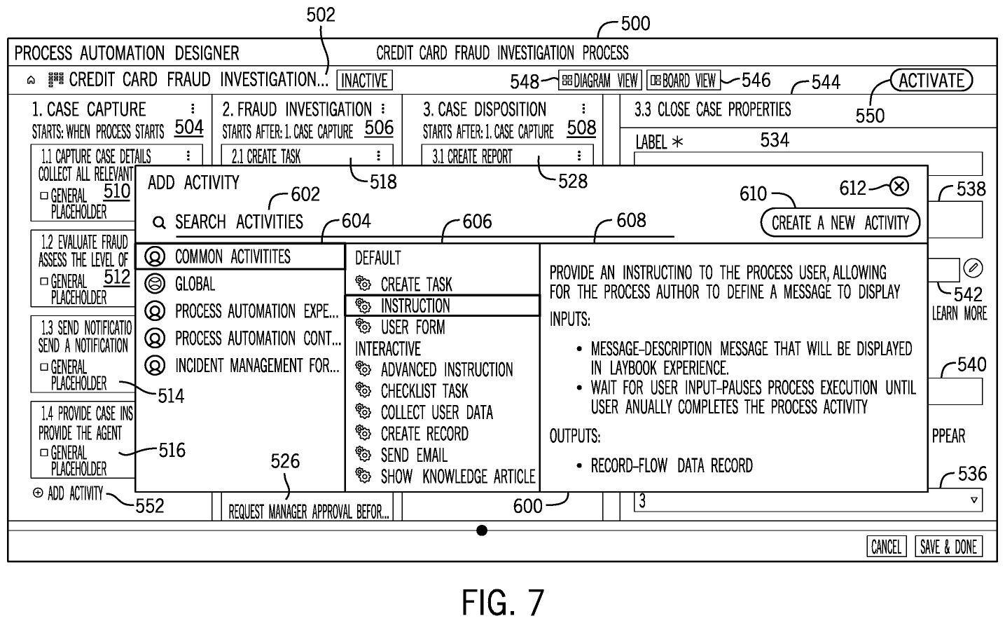

Once the workflow has been reviewed, an activate button 550 may be selected to finalize the skeleton workflow 502 and turn the skeleton workflow 502 into an approved workflow ready for execution. However, before finalizing the workflow 502, a designer may wish to add activities, further define placeholder activities, and/or replace placeholder activities with other activities. For example, activities may be added to the workflow 502 by selecting the add activity button 552 below the last activity card in each stage. Upon selection of the add activity button 552, an add activity window may be displayed. FIG. 7 shows the screenshot of the GUI 500 that includes the add activity window 600. In some embodiments, the add activity window 600 may include a search activities field 602 configured to receive inputs (e.g., alphanumeric text) that may be used as queries to search for particular activities to add to the workflow 502. When the search activities field 602 is used, results from the search may be displayed within the add activity window 600. If the results include multiple activities, an input may be received selecting an activity from the list of results.

Alternatively, activities may be found by navigating through one or more menus. For example, an activity categories list 604 may list available activity categories. For example, in the instant embodiment, the available activity categories include common activities, global activities, process automation experience activities, process automation content activities, and incident management for services activities. However, it should be understood that the activity categories shown in FIG. 7 are merely examples and that other activity categories may be available.

Upon receiving a selection of a particular activity category, the add activity window 600 may display an activity list 606 that lists the activities that fall within the selected particular category. In the instant embodiment, the common activities category has been selected from the activity categories list 604, so the activity list 606 includes a create task activity (e.g., to create a new task), an instruction activity (e.g., to provide instructions about how to perform a task), a user form activity (e.g., to create and/or present a form to be filled out), an advanced instruction activity (e.g., to provide advanced instructions about how to perform a task), a checklist task activity (e.g., to create and/or present a checklist), a collect user data activity (e.g., to collect one or more pieces of data from a user), a create record activity (e.g., to create record based on received data), a send email activity (e.g., to send an email to a recipient conveying certain information), and a show knowledge article activity (e.g., to display a knowledge article). As shown, in some embodiments, the activity list 606 may list the activities broken up into one or more groups. For example, in the embodiment illustrated in FIG. 7, the activity list 606 is further broken up into default activities and interactive activities. However, it should be understood that the activities shown in the activity list 606 are merely examples and that embodiments are envisaged having different activities and/or with activities broken into different groups.

Upon selection of an activity from the activity list 606, an activity details window 608 may be configured to display more information about the selected activity. For example, in the illustrated embodiment, an instruction activity has been selected, so the activity details window 608 displays a description of the selected instruction activity (e.g., that the instruction activity provides an instruction to the process user, allowing for the process author to define a message to display). Further, the activity details window 608 may display other characteristics of the selected activity, such as inputs and/or outputs. In the instant embodiment, the selected instruction activity includes inputs of a message displayed during the playbook experience, and a wait for user input that pauses the process execution until the process activity has been completed. In the instant embodiment, the selected instruction activity generates an output of a flow data record that may be generates based on one or more of the inputs and/or received data.

Upon selection of the create new activity button 610, a new activity of the selected type may be added to the workflow 502 (e.g., in the stage in which the add activity 552 was selected. Once the activity has been created, the activity may be selected and properties of the activity may be displayed and/or modified in the activity properties window 544. Alternatively, to close the add activity window 600 without creating a new activity, a close window 612 button may be selected.

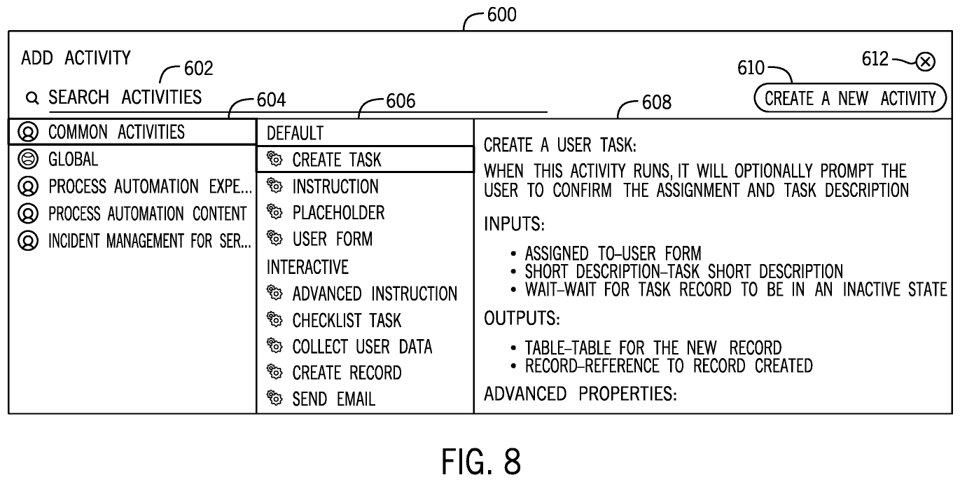

FIGS. 8-11 illustrate embodiments of the add activity window 600 in which different activities have been selected. For example, FIG. 8 illustrates an embodiment of the add activity window 600 in which a create task activity has been selected from the activities list 606. As shown, the create task activity, when executed, creates a new user task. Accordingly, when the create task activity runs, a prompt is displayed to confirm the user task assignment and description of the task. As shown, the inputs for the create task activity are an assigned to field retrieved from a user form, a short description of the task, and a wait instruction to wait for the task record to be in an active state before executing the activity. Upon execution of the activity, the outputs generated include a table for the new record and the new record itself, which may be identified by reference. Though not shown in FIG. 8, the create task may include one or more advanced properties that dictate various aspects of the activity's execution.

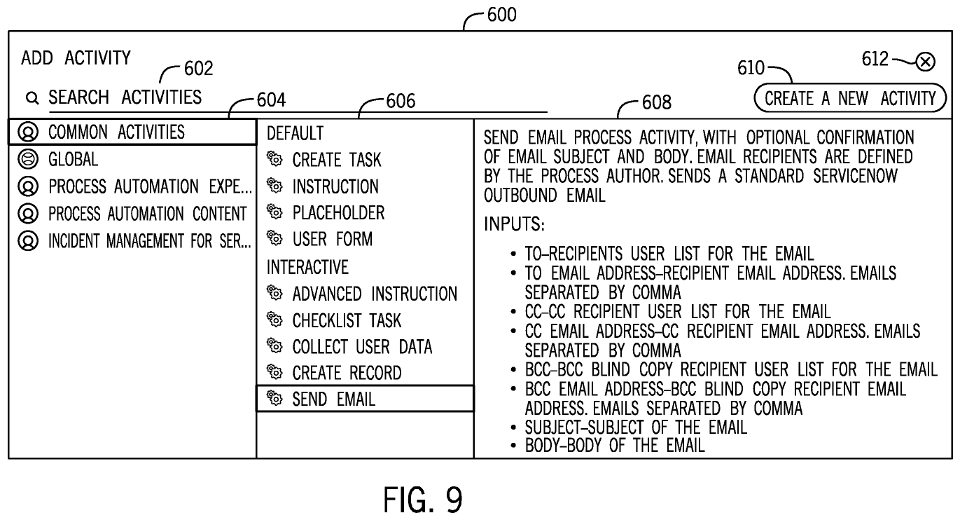

FIG. 9 illustrates an embodiment of the add activity window 600 in which a send email activity has been selected from the activities list 606. As shown, the send email activity, when executed, generates and sends an email to a recipient. Specifically, the email may reference process activity and the activity may or may not include confirmation of the email subject, body, and/or recipients. Recipients of the email may be defined by the process author or by some retrieved piece of data. Upon confirmation, a standard outbound email may be sent. As shown, the inputs for the send email task activity may include a recipient list for the email, email addresses for the recipients, copied recipients, email addresses for the copied recipients, a subject for the email, and a body for the email. Though not shown in FIG. 9, upon execution of the activity, the outputs generated include the email itself, and in some cases, confirmation of the email being sent, a read receipt, etc. Further, though not shown in FIG. 9, the send email task may include one or more advanced properties that dictate various aspects of the activity's execution.

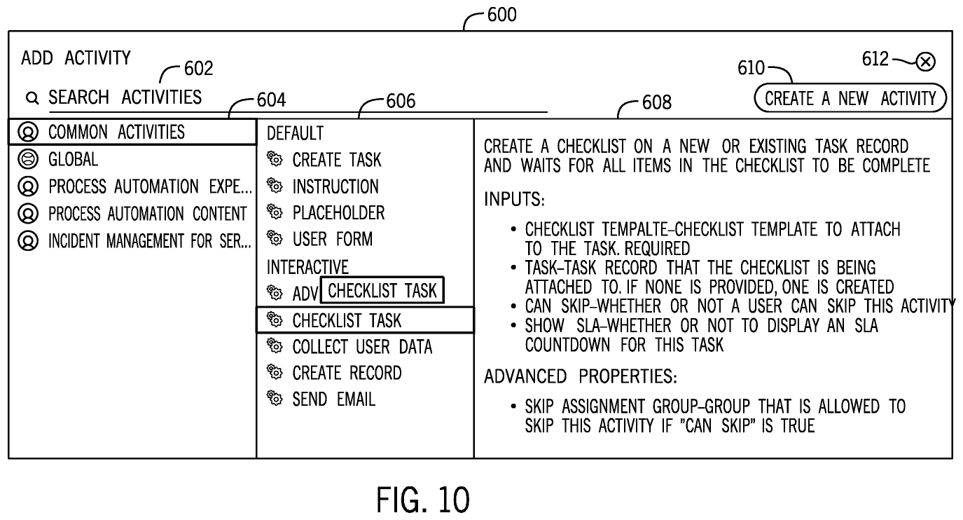

FIG. 10 illustrates an embodiment of the add activity window 600 in which a checklist task activity has been selected from the activities list 606. As shown, the checklist task activity, when executed, generates a checklist for a new or existing task record. In some embodiments, the presence of a checklist may cause the workflow to wait for all of the items in the checklist to be completed before proceeding to the next task or activity. As shown, the inputs for the checklist task activity may include a checklist template to use, identification of a task or activity with which the checklist is assigned, an indication of whether each task/activity or item can be skipped, and an indication of whether or not a service level agreement (SLA) countdown will be displayed. Though not shown in FIG. 10, upon execution of the activity, the outputs generated include, for example, a confirmation that the checklist has been completed, an indication of items that have not yet been completed, etc. Further, the checklist task may include one or more advanced properties that dictate various aspects of the activity's execution, such as one or more groups that are allowed to skip the activity if the “can skip” data field is true.

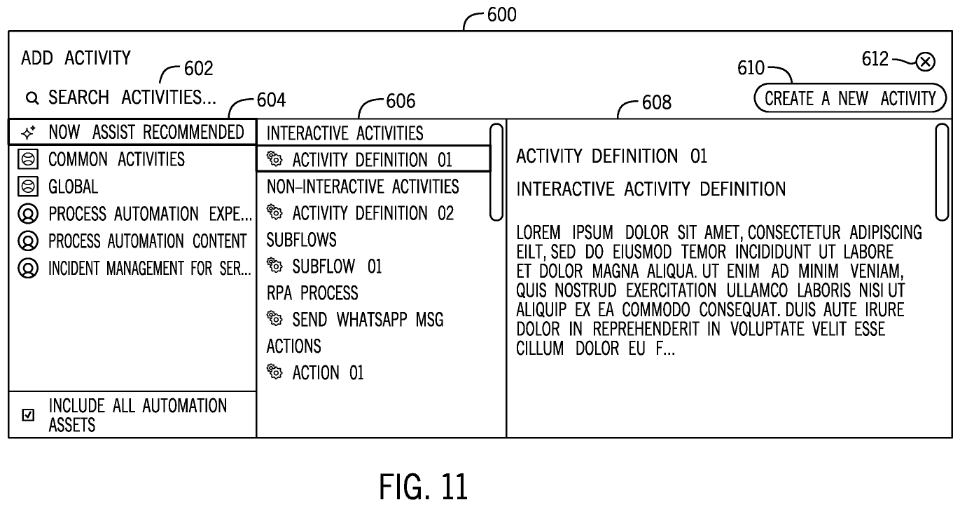

FIG. 11 illustrates an embodiment of the add activity window 600 in which recommended activities have been selected in the activity categories list 604 and the activities list 606 is populated with recommended activities. For example, an input may be received selecting the “Now Assist Recommended” categories from the activity categories list. The activities list 606 may then be populated with various recommended activities. In some embodiments, activities may be recommended (e.g., using an LLM trained on existing workflows, business data, BPMN, industry standard operating procedures, a curated set or library of activities, and so forth) based on one or more characteristics of the workflow, other similar workflows, historical data from the user profile generating the workflow, etc. As shown, in some embodiments, the recommended activities may be broken up into groups, such as interactive activities, non-interactive activities, subflows, RPA process, actions, etc. Recommended activities may be selected from the activities list 606 to replace placeholder activities in a workflow or otherwise be added to a workflow.

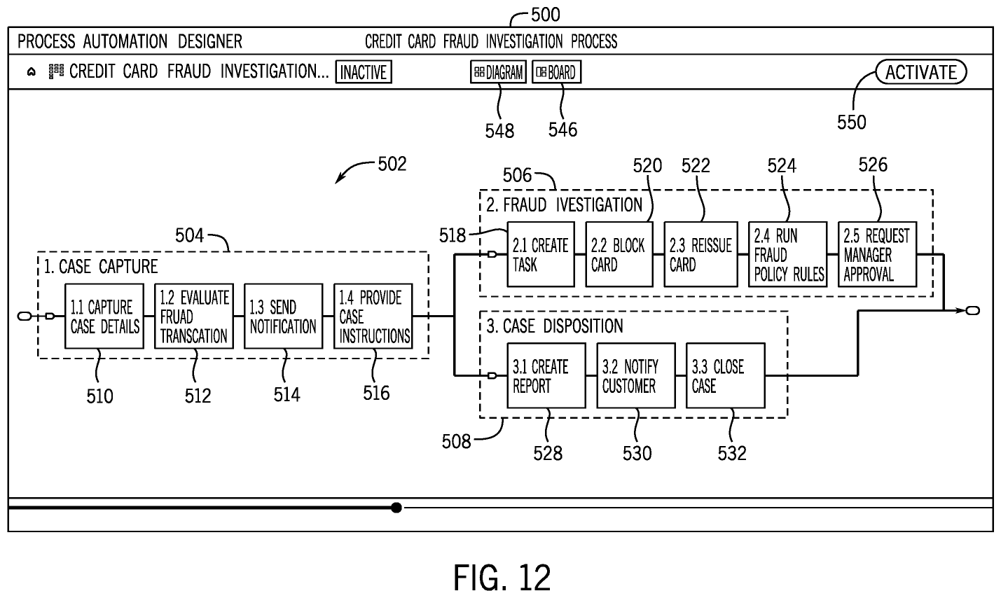

Returning to FIG. 7, as previously described, the workflow 502 is displayed in a board format, with activities represented by cards stacked in vertical lanes that represent various stages of the workflow 502. The board mode display is further indicated by the board mode indicator 546 being selected. However, when the diagram mode indicator 548 is selected, the GUI 500 may update to display the workflow 502 in a diagram mode. FIG. 12 illustrates the workflow 502 displayed in diagram mode, which is in a flow chart format. As shown, each activity is represented by a box, with arrows connecting the boxes to indicate the order in which the activities are performed. The stages are represented by shaded boxes in which the activity boxes are disposed. As described with regard to FIG. 6, if an activity is selected, the activity properties window 544 for the selected activity may be presented, allowing for modification and/or specification of one or more properties of the selected activity.

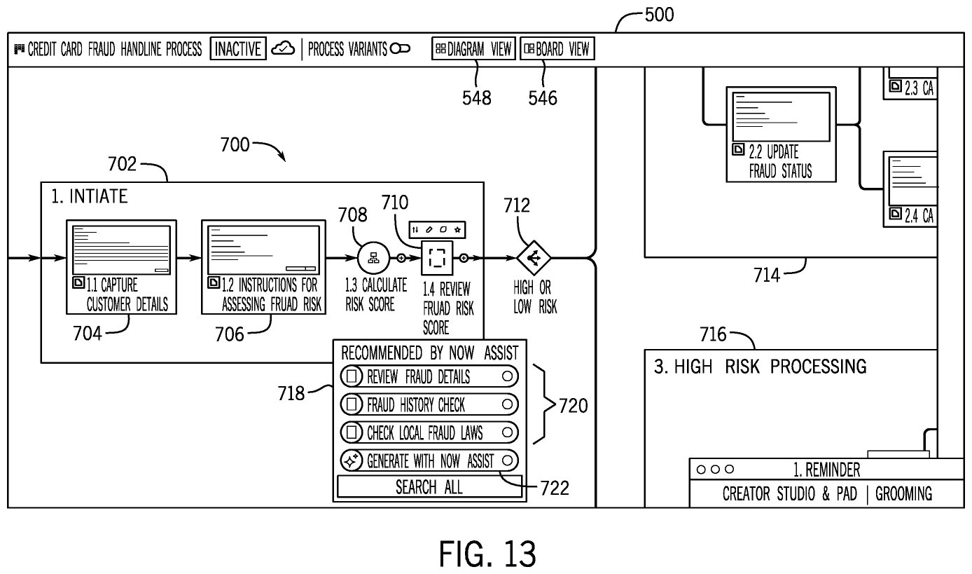

As described with regard to FIGS. 4-6, the workflow generation tool may be configured to receive an input request to generate a workflow and then output a skeleton workflow populated with placeholder activities. However, in some embodiments, the workflow generation tool may also be configured to generate suggestions as the placeholder activities are defined and/or replaced with other activities to fill in the workflow. FIG. 13 illustrates an embodiment in which the workflow generation tool makes suggestions via a popup window. The GUI 500 of FIG. 13 displays a workflow 700 for credit card fraud handling, which is slightly different from the credit card fraud investigation workflow 502 shown in FIGS. 6-12, in diagram view 548. As shown, the credit card fraud handling workflow 700 includes an initiate stage 702 that includes a capture customer details activity 704, an instructions for assessing fraud risk activity 706, a calculate risk score activity 708, a and a review fraud risk score activity 710. As shown, the capture customer details activity 704 and the instructions for assessing fraud risk activity 706 are fully defined activities, as evidenced by the activities appearing as cards within the workflow 700. However, the review fraud risk score activity 710 is a placeholder activity, as evidenced by it appearing as a blank box including a dotted box. Correspondingly, the calculate risk score activity 708 may trigger a subflow for calculating the risk score, as evidenced by the activity being represented by a subflow icon. At decision icon 712, the workflow 700 determines whether the fraud risk score is high or low. If the risk score is low (e.g., below some threshold value), the workflow 700 proceeds to the low risk processing stage 714, which includes multiple activities not shown or described. If the risk score is high (e.g., above some threshold value), the workflow 700 proceeds to the high risk processing stage 716, which includes multiple activities not shown or described.

As the workflow is being reviewed and activities of the workflow 700 are being defined and/or added, the workflow generation tool may generate recommendations for adding activities, replacing existing activities, modifying existing activities, and so forth. In the illustrated embodiment, recommendations for replacing/defining the review fraud risk score placeholder activity 710 may be presented via a popup window 718. As shown, the popup window 718 may include a list of one or more recommended activities 720 (e.g., review fraud details, fraud history check, check local fraud laws, etc.). Recommended activities 720 may be determined using an LLM trained on existing workflows, business data, BPMN, industry standard operating procedures, a curated set or library of activities, and so forth. In some embodiments, the popup window 718 may also include a generate button 722, which may utilize generative AI (e.g., an LLM trained on existing workflows, business data, BPMN, industry standard operating procedures, a curated set or library of activities, and so forth) to recommend activities, generate new activities, replace/modify existing activities and/or populate/modify properties for existing activities based on training data, other activities in the workflow, contextual information, etc. Upon receipt of an input selecting an option in the popup window, the workflow generation tool may take one or more actions to modify the workflow 700 based on the received input (e.g., define or replace a placeholder activity based on the selection, add an activity to a workflow, etc.).

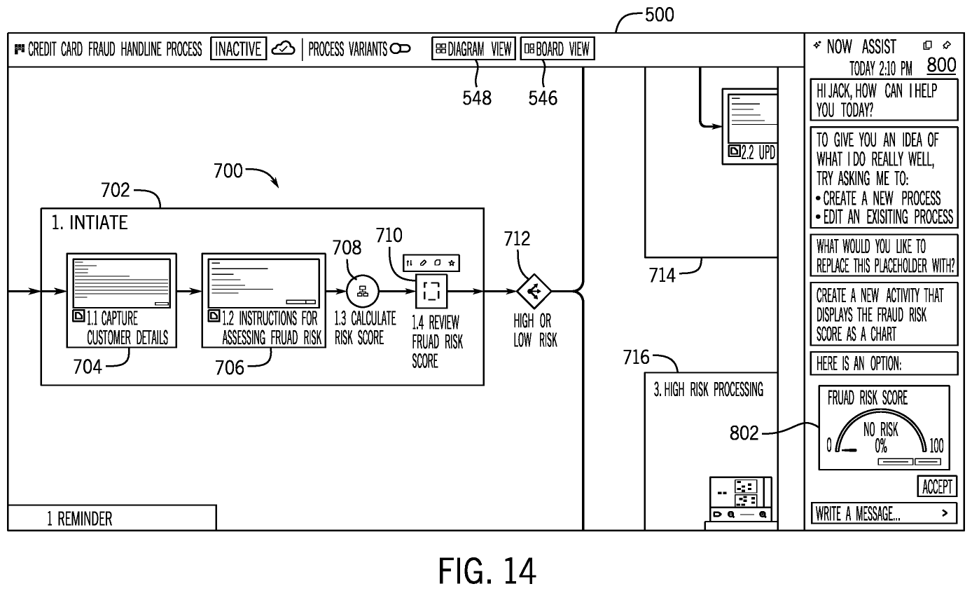

In other embodiments, recommendations may be provided via an interactive chat window rather than a popup window 718. FIG. 14 illustrates an embodiment in which the workflow generation tool makes suggestions via an interactive chat window 800. As shown, workflow generation tool utilizes the one or more LLMs to facilitate a chat session with a workflow designer profile. The workflow generation tool asks how it can help, provides some examples of its capabilities, and then asks about replacing a placeholder activity with a fully defined activity. The workflow designer profile provides an input requesting that the placeholder activity be replaced with a new activity that displays fraud risk score as a chart. The workflow generation tool uses the one or more LLMs to generate an option for the requested chart and displays a sample chart 802 in the chat window. The workflow designer profile accepts the sample chart 802. The workflow generation tool replaces the review fraud risk score placeholder activity 710 with a new fully defined activity.

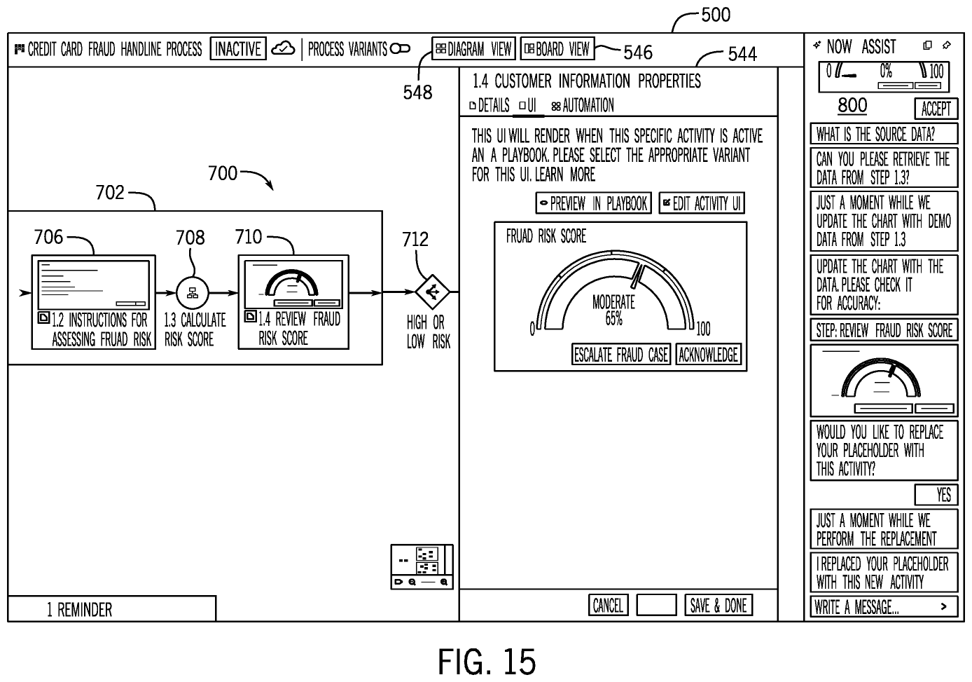

FIG. 15 illustrates the GUI 500 in which the review fraud risk score placeholder activity 710 has been replaced with a new fully defined activity 710. The GUI 500 has also displayed an activity properties window 544 for the new activity 710. As previously described, the activity properties window 544 displays properties of a selected activity that can be edited to modify the activity. In the embodiment shown in FIG. 15, the activity properties window 544 includes a details tab, a user interface (UI) tab, and an automation tab. The details tab, when selected, causes the activity properties window 544 to display the various properties of the activities as previously shown and described with regard to FIG. 6. The UI tab, when selected, causes the activity properties window 544 to display various characteristics and/or representations of elements (e.g., graphs, charts, widgets, icons, forms, animations, etc.) of the user interface displayed as the activity is executed. The automation tab may be used to specify various aspects of the activity that may be performed autonomously without input from a user profile. In the embodiment shown in FIG. 15, the UI tab is selected and the chart accepted by the workflow designer profile is displayed. As shown, the activity properties window 544 may include buttons that, when selected, cause the UI to be previewed in a playbook and/or allows the activity to be edited.

As shown in FIG. 15, the chat conversation in the chat window 800 may continue after the chart has been accepted. For example, in the instant embodiment, the workflow generation tool asks the workflow designer profile about the source data for the chart. The workflow designer profile indicates that the data is from step 1.2, which includes instructions for assessing fraud risk. The workflow generation tool retrieves the source data, updates the chart, and asks the workflow designer profile to confirm, then confirms that the placeholder activity is to be replaced with a new activity that generates the agreed upon chart.

In some embodiments, the chat messages that appear in the chat window 800 may be transmitted from the client device to the remote/cloud instance and responses may be generated by the workflow generation tool running on the remote/cloud instance and transmitted to the client device. In other embodiments, the workflow generation tool may run on the client device and generate responses to chat messages locally. In such embodiment, each message in the chart exchange may not be transmitted back and forth between the client device and the remote/cloud instance.

It should be understood, however, that the recommendations and activity replacements shown in FIGS. 11, 13-15, as well as the chat session shown in FIGS. 14-15 are merely illustrative examples and that other embodiments are envisaged in which the workflow generation tool makes other recommendations and/or assists a workflow designer profile with other tasks associated with creating a new workflow, modifying an existing workflow, defining a skeleton workflow, and so forth.

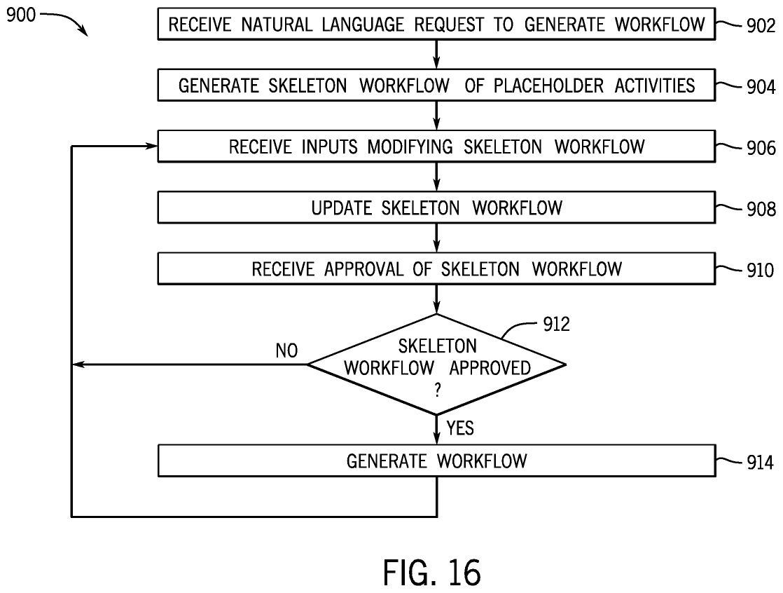

FIG. 16 is a flow chart of a process 900 for generating a workflow. At block 902, the process 900 receives a natural language request to generate a workflow. The workflow may represent any process carried out in the operation of an enterprise or organization. For example, the workflow may be related to credit card fraud investigation, employee onboarding, employee training, accounting, financial close, employee reviews, product testing, invoicing/billing, quality control, IT security, purchasing, inventory, logistics, employee benefit management, software development, supply chain management, vendor onboarding, and so forth.

At 904, the process 900 uses one or more LLMs to generate a skeleton workflow populated with placeholder activities, which may or may not be grouped into stages, based on the received request. The process 900 may use the one or more LLMs to build the skeleton workflow placeholder-activity-by-placeholder-activity. Each placeholder activity may include proposed placeholder values for one or more properties of the corresponding placeholder activity. For example, placeholder activities may include proposed placeholder values for inputs, outputs, actions that take place to generate the outputs based on the inputs, a label, a description, rules to apply during performance of the activity, triggers that initiate the activity, advanced properties of the activity, or any combination thereof.

The LLMs may be trained on existing workflows (e.g., within the enterprise, across an industry, across multiple industries, etc.), business process model and notation (BPMN) conventions, industry standard operating procedures, industry best practices, publicly available information, publications, data from the Internet, and so forth. In some embodiments, the one or more LLMs may be “off the shelf” or “out of the box” LLMs provided by a service provider and not unique to the client instance. However, in other embodiments, the LLMs may be customized to the client instance, either with specific training, specific customized settings, or both.

At block 906, the process 900 may receive inputs modifying the skeleton workflow. For example, the process 900 may receive inputs requesting modifications to or making edits to the skeleton workflow, and/or providing feedback to the workflow generation tool. Such modifications may include defining or editing properties of the one or more placeholder activities to convert the placeholder activities into fully defined activities, replacing placeholder activities with existing activities selected from a library or other workflow, replacing placeholder activities with new activities, removing placeholder activities, and so forth. As described with regard to FIGS. 13-15, the workflow generation tool may use popup windows and/or chat windows to make recommendations to modify the workflow and/or receive feedback from a workflow designer profile.

At 908, the workflow is updated based on the inputs received. In some embodiments, updating the workflow may include merely implementing specific edits received, whereas in other embodiments, updating the workflow may include receiving and interpreting less explicit inputs (e.g., “can this be displayed as a chart?”), and/or a chat exchange and determining how to update the workflow. Receiving feedback/modifications and updating the workflow may continue iteratively until the workflow is fully defined and/or approval is received (block 910, e.g., from a workflow designer profile).

At block 912, if the workflow is approved, the process 900 proceeds to block 914 and generates a fully defined and operational workflow. If the workflow has not been approved, the process 900 returns to block 906 and receives additional inputs modifying the workflow.

The presently disclosed techniques are directed to a workflow generation tool that builds workflows, and in some cases entire playbooks (e.g., complete workflows along with GUIs presented as the workflow is performed), based on natural language inputs provided via the workflow generation tool, using large language models (LLMs). Specifically, a natural language input identifying one or more characteristics of a workflow to be generated may be provided via the workflow generation tool (e.g., “I would like to create an onboarding workflow”). The workflow generation tool utilizes one or more LLMs to generate a skeleton workflow, including multiple placeholder activities, which may or may not be grouped into stages. The one or more LLMs may be trained on existing workflows (e.g., within the enterprise, across an industry, across multiple industries, etc.), business process model and notation (BPMN) conventions, industry standard operating procedures, industry best practices, publicly available information, publications, data from the Internet, and so forth. The one or more LLMs may build the skeleton workflow placeholder activity by placeholder activity, with each placeholder activity having proposed placeholder values for the one or more properties of the corresponding activity. For example, a placeholder activity of the skeleton workflow may include proposed placeholder values for inputs, outputs, actions that take place to generate the outputs based on the inputs, a label, a description, rules to apply during performance of the activity, triggers that initiate the activity, advanced properties of the activity, or some combination thereof.

A skeleton workflow generated by the workflow generation tool may be displayed via the workflow generation tool, which may receive inputs making edits to the skeleton workflow and/or providing feedback to the workflow generation tool. For example, the inputs may confirm proposed placeholder values or provide replacement values for one or more properties of the activity, provide values for one or more properties of the activity where placeholder values were not provided by the workflow generation tool, add new activities, remove activities, replace placeholder activities with activities selected from an activity library or new activities, and so forth. Further, in some embodiments, the workflow generation tool may present suggestions for replacing placeholder activities with activities from a library when a placeholder activity is selected. In further embodiments, the workflow generation tool may include a chat interface by which feedback on the skeleton workflow may be provided in natural language and the workflow generation tool uses the one or more LLMs to make changes to the skeleton workflow based on the feedback provided. Once the properties for all of the activities in the skeleton workflow have been finalized, the skeleton workflow may be finalized and a usable workflow generated.

In some embodiments, the workflow generation tool may be configured to generate a complete playbook, which includes a complete workflow, as opposed to a skeleton workflow, along with one or more GUIs to be displayed as the workflow is performed. In such embodiments, changes to the complete workflow may be received (e.g., add/remove activities, specify different values for activity properties, etc.), and/or feedback on the playbook received via a chat interface or the workflow generation tool, which may cause the workflow generation tool to make changes to the playbook based on the feedback received via the workflow generation tool.

Technical effects of the disclosed techniques may include lower processor utilization and reduced computational costs associated with less time spent designing workflows. Further, deployment of the presently disclosed techniques may reduce human hours spent designing workflows, as well as problems with workflows resulting from human error.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a natural language request to generate a workflow, wherein the natural language request specifies at least one characteristic of the workflow;
generating, using one or more large language models (LLMs), a skeleton workflow based on the at least one characteristic, wherein the skeleton workflow includes first and second placeholder activities, and wherein the first placeholder activity comprises a first placeholder value for a first property of the first placeholder activity;
receiving an input requesting to modify the skeleton workflow; and
updating the skeleton workflow based on the input.

2. The method of claim 1, comprising:
receiving an approval of the updated skeleton workflow; and
generating, in response to receiving the approval of the skeleton workflow, the workflow based on the approved updated skeleton workflow.

3. The method of claim 2, comprising generating one or more graphical user interfaces (GUIs) configured to be displayed via a client device as the workflow is carried out.

4. The method of claim 1, wherein generating the skeleton workflow comprises:
generating, using the one or more LLMs, based on the natural language request, the first placeholder activity;
setting, for the first placeholder activity, using the one or more LLMs, based on the natural language request, the first placeholder value for the first property of the first placeholder activity;
generating, using the one or more LLMs, based on the natural language request and the first placeholder activity, the second placeholder activity; and
setting, for the second placeholder activity, using the one or more LLMs, based on the natural language request and the first placeholder activity, a second placeholder value for a second property of the second placeholder activity.

5. The method of claim 1, wherein the first property of the first placeholder activity comprises an input to the first placeholder activity, an output of the first placeholder activity, one or more actions that take place to generate the output of the first placeholder activity based on the input to the first placeholder activity, a label of the first placeholder activity, a description of the first placeholder activity, a rule to apply during performance of the first placeholder activity, a trigger that initiates the first placeholder activity, or an advanced property of the first placeholder activity.

6. The method of claim 1, wherein the input modifying the skeleton workflow comprises providing a value for an additional property of the first placeholder activity, adding a third activity, removing the second activity, replacing the second placeholder activity with a fourth activity selected from an activity library, or any combination thereof.

7. The method of claim 1, wherein the input modifying the skeleton workflow is provided via a chat interface.

8. The method of claim 1, wherein the one or more LLMs are trained on one or more other workflows, one or more business process model and notation (BPMN) conventions, one or more industry standard operating procedures, one or more industry best practices, one or more publications, or any combination thereof.

9. A system, comprising:
processing circuitry; and
a memory, accessible by the processing circuitry, and storing instructions that, when executed by the processing circuitry, cause the processing circuitry to perform operations comprising:
receiving a natural language request to generate a workflow, wherein the natural language request specifies at least one characteristic of the workflow;
generating, using one or more large language models (LLMs), a skeleton workflow based on the at least one characteristic, wherein the skeleton workflow includes first and second placeholder activities, and wherein the first placeholder activity comprises a first placeholder value for a first property of the first placeholder activity;
receiving an input requesting to modify the skeleton workflow;
updating the skeleton workflow based on the input;
receiving an approval of the updated skeleton workflow; and
generating, in response to receiving the approval of the skeleton workflow, the workflow based on the approved updated skeleton workflow.

10. The system of claim 9, wherein the processing circuitry is configured to execute a cloud-based client instance, and wherein the natural language request to generate the workflow, the input requesting to modify the skeleton workflow, and the approval of the updated skeleton workflow are received from a client device.

11. The system of claim 9, wherein generating the skeleton workflow comprises:
generating, using the one or more LLMs, based on the natural language request, the first placeholder activity;
setting, for the first placeholder activity, using the one or more LLMs, based on the natural language request, the first placeholder value for the first property of the first placeholder activity;
generating, using the one or more LLMs, based on the natural language request and the first placeholder activity, the second placeholder activity; and
setting, for the second placeholder activity, using the one or more LLMs, based on the natural language request and the first placeholder activity, a second placeholder value for a second property of the second placeholder activity.

12. The system of claim 9, wherein the first property of the first placeholder activity comprises an input to the first placeholder activity, an output of the first placeholder activity, one or more actions that take place to generate the output of the first placeholder activity based on the input to the first placeholder activity, a label of the first placeholder activity, a description of the first placeholder activity, a rule to apply during performance of the first placeholder activity, a trigger that initiates the first placeholder activity, or an advanced property of the first placeholder activity.

13. The system of claim 9, wherein the input modifying the skeleton workflow is received via a chat interface.

14. The system of claim 13, wherein the operations comprise displaying, via the chat interface, one or more recommendations for modifying the skeleton workflow.

15. The system of claim 9, wherein the operations comprise displaying, via a popup window, a recommendation for modifying the skeleton workflow.

16. The system of claim 15, wherein the recommendation for modifying the skeleton workflow comprises replacing the first placeholder activity with an existing activity.

17. A non-transitory, computer readable medium comprising instructions that, when executed by processing circuitry, cause the processing circuitry to perform operations comprising:
receiving a natural language request to generate a workflow, wherein the natural language request specifies at least one characteristic of the workflow;
generating, using one or more large language models (LLMs), a skeleton workflow based on the at least one characteristic, wherein the skeleton workflow includes first and second placeholder activities, and wherein the first placeholder activity comprises a first placeholder value for a first property of the first placeholder activity;
generating one or more graphical user interfaces (GUIs) configured to be displayed via a client device as the workflow is carried out;
receiving an input requesting to modify the skeleton workflow; and
updating the skeleton workflow based on the input.

18. The non-transitory, computer readable medium of claim 17, wherein the operations comprise:
receiving an approval of the updated skeleton workflow; and
generating, in response to receiving the approval of the skeleton workflow, the workflow based on the approved updated skeleton workflow.

19. The non-transitory, computer readable medium of claim 17, wherein generating the skeleton workflow comprises:
generating, using the one or more LLMs, based on the natural language request, the first placeholder activity;
setting, for the first placeholder activity, using the one or more LLMs, based on the natural language request, the first placeholder value for the first property of the first placeholder activity;
generating, using the one or more LLMs, based on the natural language request and the first placeholder activity, the second placeholder activity; and
setting, for the second placeholder activity, using the one or more LLMs, based on the natural language request and the first placeholder activity, a second placeholder value for a second property of the second placeholder activity.

20. The non-transitory, computer readable medium of claim 17, wherein the operations comprise transmitting a graphical representation of the skeleton workflow to an additional client device for display via a user interface of the additional client device.
